(19) United States
(12) Patent Application Publication
(10) Pub. No.: US 2013/0166271 A1
(43) Pub. Date: Jun. 27, 2013

(54) SIMULATING AND TESTING AVIONICS

(71) Applicants: Torkel Danielsson, Linkoping (SE); Anders Pettersson, Linkopng (SE)

(72) Inventors: Torkel Danielsson, Linkoping (SE); Anders Pettersson, Linkopng (SE)

(21) Appl. No.: 13/808,839

(22) PCT Filed: Jul. 6, 2010
(86) PCT No.: PCT/SE10/50786

§ 371 Date: Mar. 7, 2013

(51) Int. Cl. G06F 17/50

(52) U.S. Cl. CPC G06F 17/5009
USPC 703/22

(57) ABSTRACT

An avionics application host system and method for simulating and/or testing a plurality of partitioned applications arranged to be periodically executed on a target system. The target system is a distributed avionics control system of an aerial vehicle. The host system includes a plurality of functional modules. The plurality of functional modules includes: an application module arranged to import the plurality of partitioned applications in un-modified form, a configuration module arranged to configure the operations of the host system, at least one communication module arranged to provide communication between the partitioned applications, a control module arranged to provide coordinated execution time to the functional modules, a service module associated to each imported partitioned application arranged to provide services to the imported partitioned applications so as to enable execution of the imported partitioned applications and to preserve the temporal order of events related to communication and execution.

### TECHNICAL FIELD

The present invention relates to a system and a method for simulating and testing avionics.

Furthermore, the invention relates to software adapted to perform steps of the simulation and test method when executed on a computer.

### BACKGROUND OF THE INVENTION

In embedded control systems of today, developments in digital technology have enabled complex functionality. However as a direct result from the development, the need of additional system capacity provided by software and various components such as sensors, processors, display units, data buses and memory units is increasing.

Apart from implementing more functionality and interconnectivity in control systems, using less Space Weight and Power (SWaP) and a reduced number of cabling are further important drivers. Updates of embedded hardware and software during a products life span make adaptability and modularity another interesting design parameter. Other incentives include achieving cost efficient development, production and maintenance, where one possible route is to implement Commercial-Of-The-Shelf (COTS) technology instead of expensive specialized technology.

Real-time systems for safety critical control applications, wherein typically data from sensor/s are acquired, communicated and processed to provide a control signal to an actuator pose strict demands regarding bandwidth, data delivery time, redundancy, and integrity. Failure to meet one or several of these demands can in applications including “brake-by-wire” or “steer-by-wire” prove dangerous.

One such area wherein reliable high-speed real-time execution and communication of data is applicable is within avionics systems. Advances in technology during late 1960 and early 1970 made it necessary to share information between different avionics subsystems in order to reduce the number of Line replaceable units (LRU:s). A single sensor such as a position sensor provided information to weapon systems, display system, autopilot and navigation system.

The high level architecture of avionics systems has gone from federated meaning separate LRU:s for separate functions to integrated modular avionics (IMA) meaning several functions integrated into multifunctional LRU:s. The connectivity allowing communication between different LRU:s has gone from low bandwidth point-to-point connections to higher bandwidth point-to-multipoint connections.

Guidance set out by Radio Technical Commission for Aeronautics (RTCA) in DO-178B and RTCA DO-254 regulates how to design and develop software and respective hardware in a safe way in order to show airworthiness, according to a criticality scale. However certification and subsequent recertification of software according to the DO-178B represents a substantial cost of developing software based avionic control systems.

In order to assist development of modern control systems for avionics a set of guidance documents such as RTCA DO-297 and Aeronautical Radio Inc. (ARINC) 651 defines general concepts for IMA systems. Further ARINC 653 “Avionics application software standard interface”, defines an Application Program Interface (API) referred to as Application Executive (APEX), implemented in Real-Time Operating Systems (RTOS) used for avionic control systems. ARINC 653 allows for space and time partitioning that may be used wherever multiple applications need to share a single processor and memory resource, in order to guarantee that one application cannot bring down another in the event of application failure.

DE102006018181A1 discloses a method that involves controlling communication between a testing function control and interface adjusting routines by using a network distribution routine. The adjusting routines implement interfaces e.g. RS232 interface, of a system under test e.g. control components of an airplane, and generate hardware- and/or software specific interface events as a separate algorithm for the control. The events are generated as the separate algorithm for stimulating the interfaces independent of transmitted testing function information or to use responses of the interfaces for evaluation.

U.S. Pat. No. 5,111,402A1 discloses an integrated aircraft system for functionally testing the components and subsystems of an aircraft during its manufacture and subsequent maintenance. A central control unit serves as a repository for test applications and instruction sets that comprise the individual steps of the functional tests performed on the aircraft. In response to receiving indications of work performed on the aircraft, the central control unit displays an indication of the functional tests that should be performed on the aircraft.

US20080009983A1 discloses flight control system for aircraft and test system for testing such a flight control system. The test system comprises a test device which makes it possible to have access to the information available on a flight control system and to take over at least one computer of that flight control system.

EP0652526A1 discloses an aircraft test system which generates stimuli that emulate the stimuli received by an aircraft when in flight. The aircraft test system includes a number of instruments for generating the number of processor-controllable instruments for generating stimuli received by an aircraft when in flight. The system also includes a number of instruments that monitor the response of the various aircraft components to the stimuli to which the aircraft is exposed.

However, developing avionics software applications tend to require access to target system hardware before any testing and/or simulation of the behavior of the developed avionics applications can be performed. Furthermore access to the target hardware system for testing the developed avionics software applications tends to be a highly limited resource, since many software developers generally partake in the development of applications and each requiring access to test their developed application. Moreover an assembly of the real target hardware system provided for testing purposes typically represents a substantial cost.

Accordingly, there is a need in the art for improvements, intended to facilitate test and simulation of the functionality of avionics software applications.

### OBJECTIVE OF THE INVENTION

It is therefore an objective of the present invention to provide a system and a method which achieve facilitated simulation and testing of avionics software applications.

### SUMMARY OF THE INVENTION

This objective is achieved according to the present invention by an avionics application host system for simulating and/or testing a number of partitioned applications arranged to be periodically executed on a target system, wherein the target system is a distributed avionics control system of an aerial vehicle. The host system comprising a number of functional modules, wherein the number of functional modules comprises: an application module arranged to import said number of partitioned applications in un-modified form, a configuration module arranged to configure the operations of the host system, based on configuration tables associated to the target system, wherein said configuration of the operations relates to specifications of execution, communication and memory access associated to the partitioned applications, at least one communication module associated to the imported partitioned applications arranged to provide communication between the partitioned applications and between component processes within the partitioned applications, based on said configuration tables, a control module arranged to provide coordinated execution time to the functional modules, based on receiving a plurality of requests for execution time from the functional modules, wherein each of the plurality of requests comprise information related to requested execution start-time, wherein the control module further is arranged to determine the order of execution among a plurality of requests, based on said requested execution start-time, a service module associated to each imported partitioned application arranged to provide services to the imported partitioned applications related to execution and communication via standard target application interface, based on wrapping requests for services from the imported partitioned applications via a number of wrapper objects on to the communication module and control module, so as to enable execution of the imported partitioned applications and to preserve the temporal order of events related to communication and execution.

It is achieved that the partitioned applications arranged to be periodically executed on the target system can be executed within the avionics host system without porting the partitioned applications to the avionics host system. The avionics host system can be used as a desktop simulator tool for developing partitioned applications for control computers. Applications developer can build partitioned applications for the target system and execute the partitioned applications in the simulated environment using the avionics host system. It is further possible to debug the system, to investigate and modify messages and data sent between the partitioned avionics applications. The avionics host system gives the application developers the possibility to test the partitioned applications in a desktop environment before one or more components of the target system hardware or an assembly of the target system hardware is available, developed and/or operable. The avionics host system allow most of the tests associated to integrating the partitioned application into the target system to be investigated and executed directly after build of the partitioned applications at the application developer's desktop.

The system is in one option characterized that the control module is arranged to simulate target system time based on receiving the plurality of requests for execution time from the functional modules and arranged to advance simulated target system time to a subsequent requested start time in rising order.

The system is in one option characterized that the control module is arranged to operate in accordance with a membership protocol and communicate with the functional modules, the partitioned applications and component processes associated to the partitioned applications, based on message queue objects.

The system is in one option characterized that the host system comprises a model module arranged to provide a plurality of physical models of the operating environment of the target system and subsystems coupled to the target system.

The system is in one option characterized that said configuration module is further arranged to provide configuration associating at least one of the number of partitioned applications to at least one variable of at least one the plurality of physical models.

The system is in one option characterized that the at least one communication module comprises a plurality of communication sub-modules and the configuration module further is arranged to provide configuration associating at least one of the number of partitioned applications to at least one variable of at least one the plurality of physical models via at least one of the plurality of communication sub-modules.

By this is achieved that the avionics host system can simulate the entire control system of the aerial vehicle i.e. target system, based on that the partitioned applications can be executed in the avionics host system and interact with simulated subsystem representative of the subsystem associated to the aerial vehicle by using the plurality of physical models such as the models of actuators, sensors and/or operating environment.

The system is in one option characterized that said plurality of communication sub-modules provide communication between component processes associated to each of the number of partitioned applications based on at least a first shared memory object associated to each of the plurality of communication sub-modules and wherein the plurality of communication sub-modules provide communication between the number of partitioned applications associated to different communication sub-modules based on a second shared memory object.

The system is in one option characterized that the at least one communication module is arranged to simulate a time-triggered Ethernet network based on a communication schedule provided by the configuration tables and a second shared memory object associated to the at least one communication module.

The system is in one option characterized that the target operating system is a real-time operating system and the host operating system is a general purpose operating system.

The system is in one option characterized that the number of partitioned applications are ARINC 653 applications and the service module (150) is arranged to provide ARINC 653 functionality.

The system is in one option characterized that the ARINC 653 partition service is mapped to UNIX processes and the partitioned applications are executed within its associated UNIX process as POSIX threads.

This objective is also achieved according to the present invention by a flight simulator comprising an avionics applications host system according to any of claims 1-11, wherein the avionics application host system comprise an input module arranged to provide means to input control commands associated to simulated flight operations and wherein the avionics application host system comprise display means arranged to provide visual feedback based on the simulated flight operations.

By this is achieved that a pilot can operate a virtual version of the aerial vehicle comprising the target system with the partitioned applications based on the avionics host system provided with input means.

This objective is also achieved according to the present invention by a method for simulating and/or testing a number of partitioned applications arranged to be periodically executed on a target system, wherein the target system is a distributed avionics system of an aerial vehicle. The method comprising the steps of: importing the partitioned applications in un-modified form into an avionics application host system, configuring operations of the avionics application host system associated to the partitioned applications based on using configuration tables associated to the target system, initializing the imported partitioned applications, wrapping requests for services related to execution from the imported partitioned applications via wrapping layers to a control module, based on transmitting at least one message comprising information related to a requested execution start-time, granting execution time based on the requested execution start times, providing virtual communication based on transmitting at least one message comprising information related to a requested execution start-time from the communication module to the control module, maintaining a simulated target system time and advancing the simulated target system time to the next requested start-time in order, so as to execute the imported partitioned applications and to preserve the temporal order of events related to communication and execution.

The dependent claims define optional characterizing features corresponding to those described in relation to the system.

This objective is also achieved by a computer programme comprising a programme code for performing the above described method steps, when said computer programme is run on a computer.

This objective is also achieved by a computer programme product comprising a program code stored on a computer readable media for performing the above described method steps, when said computer programme is run on the computer.

This objective is also achieved by a computer programme product directly storable in an internal memory of a computer, comprising a computer programme for performing the above described method steps, when said computer programme is run on the computer.

### BRIEF DESCRIPTION OF THE DRAWINGS

FIG. 1. shows schematically a distributed avionics system in accordance with an example of the invention.

FIG. 2. shows schematically the distributed avionics system integrated to components of an aerial vehicle in accordance with an example of the invention.

FIG. 3. shows a schematic block diagram of hardware components of the distributed avionics system in accordance with an example of the invention.

FIG. 4. illustrates a schematic representation of the hardware components and software in accordance with an example of the invention.

FIG. 5. illustrates a schematic representation of a portion of the software architecture in more detail.

FIG. 6. shows a schematic illustration of an execution schedule in accordance with an example of the invention.

FIG. 7. shows a schematic illustration of a simulation framework in accordance with an example of the invention.

FIG. 8. shows a schematic illustration of communication architecture within a simulation framework in accordance with an example of the invention.

FIG. 9. shows a schematic illustration of a flow diagram for a method to simulate and/or test a number of partitioned applications in accordance with an example of the invention.

### DETAILED DESCRIPTION

The present disclosure describes a system, method and computer program for simulating and testing developed software applications intended to execute on an embedded distributed control computer environment.

The developed software applications comprise source code utilizing one or more functional calls/services associated to functionality provided from the embedded distributed control computer environment. The one or more functional calls/services may for example require functionality provided from one or more particular operating system and/or one or more particular API associated to the embedded distributed control computer environment.

Also the developed software applications may be compiled to machine readable code, such as executable binaries compiled using a compiler, compatible with the embedded distributed control computer environment.

Hence, the source code or machine readable code is sensitive to the specific environment in which the software applications are intended to execute on i.e. requiring target platform specific functionality. The behaviour of the software applications is simulated and/or tested using a replicated target environment referred to as host environment or host system. Furthermore, an entire target system can be virtually tested in a simulated operating environment using models of the operating environment.

The following examples relates to the case with reference to aerial vehicles. However, various different applications are possible, such as for example land, sea or space vehicles.

A simulation or test environment or system is referred to as a “host” environment or system and the intended execution environment or system is referred to as “target” environment. A target environment is the environment in which the software applications are intended to execute and/or is compiled to.

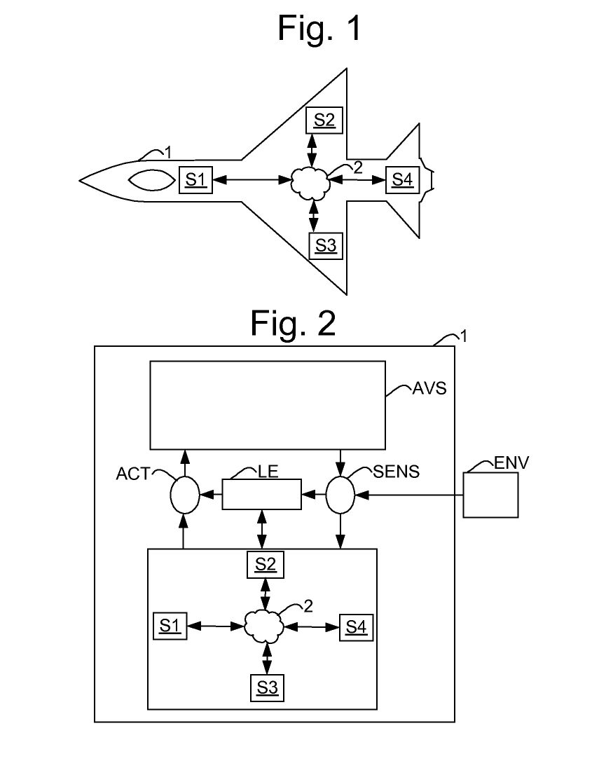

Referring to the drawings, and initially to FIG. 1, there is illustrated a target system in accordance with an example of the present invention. The target system is a distributed avionics computer system comprising a plurality of avionics computers S1-S4 arranged to be mounted in various locations of an aerial vehicle 1 and act as controller of one or more of a set of subsystems of the aerial vehicle 1, such as for example act as a controller of a fuel injection system or hydraulics of an aileron.

In FIG. 2 there is illustrated an alternative view of the distributed avionics computer system integrated into systems/components of the aerial vehicle 1 in accordance with an example of the invention. The set of subsystems of the aerial vehicle AVS may comprise systems such as for example ailerons, flaps, fuel injection and payload. The distributed avionics computer system may comprise at least one computer node S1-S4, such as a general purpose computer arranged as a flight control computer (FCC) and/or a mission control computer (MCC), arranged to be in communicative connection with various of the set of subsystems of the aerial vehicle AVS and additional systems and/or components such as sensors SENS, actuators ACT and one or more control stations. The sensors SENS may provide information related to properties of various of the set of subsystems of the aerial vehicle AVS and of an operating environment ENV surrounding the aerial vehicle 1. The one or more control stations may provide information related to interactions from one or more operators of the aerial vehicle 1. The distributed avionics computing system may be arranged to process the information provided from one or more of the sensors SENS and/or control stations, in order to provide control data to the one or more actuators ACT and/or presentation data to the control stations. The distributed avionics computer system may be coupled to at least one legacy avionics processing component LE, such as for example a legacy LRU arranged as a radar processing unit, arranged to be in communicative connection with the various avionics subsystems AVS and additional systems and/or components such as sensors SENS, actuators ACT and the one or more control stations.

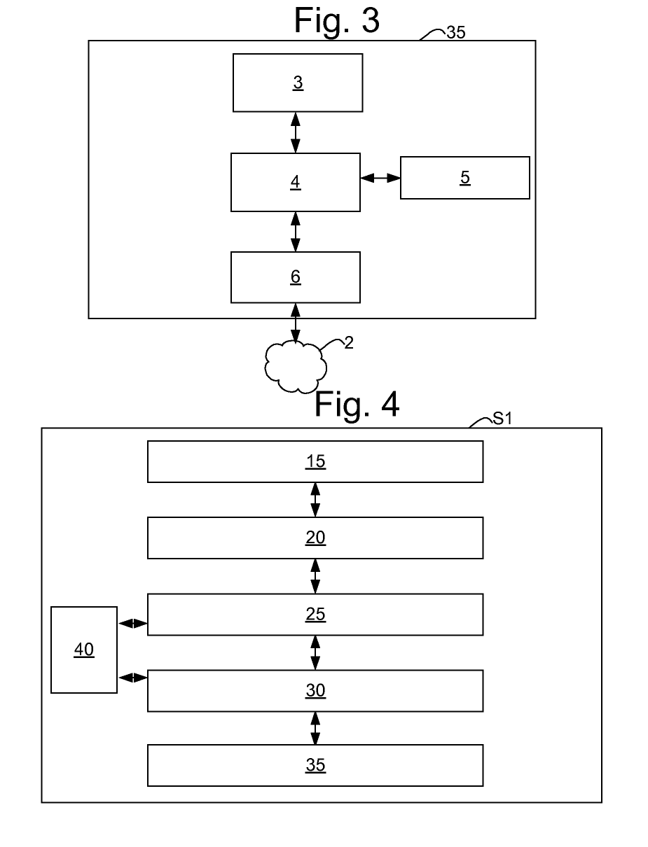

With reference to FIG. 3 the hardware configuration 35 of one of the plurality of computers S1 of the target system is illustrated in accordance with an example of the invention. Each of the plurality of computers S1-S4, hereinafter referred to as nodes S1-S4, may comprise at least a processor 4, memory 3, hardware clock (not shown), power supply (not shown), bus interface 6 and I/O interface 5. The I/O interface 5 may be arranged to provide access to system peripherals e.g. devices coupled to the respective node by means of VME, PCIe or the like. The distributed system may further comprise at least one network 2, such as for example a switched Ethernet network, operatively connecting the nodes S1-S4, thereby enabling exchange of data messages between the nodes. Access to the network may be provided by the respective bus interface 6 which may be arranged to place data messages to and/or retrieve data messages from the network 2 in accordance with predetermined instructions. The bus interface 6 may further be arranged to provide access by means of one or more additional connections to other devices such as remote data concentrators (RDC:s), sensors and/or actuators. The one or more connections to the other devices may be point-to-point connections such as RS-422 or of bus type such as MIL-STD-1553, IEEE 1394, or other similar type of connection known within the art.

In FIG. 4 the configuration relating to the high level architecture of one of each of the plurality of computers S1 of the target system is illustrated in accordance with an example of the invention. Each node S1-S4 may apart from the above described hardware 35 with reference to FIG. 2 comprise a hardware interface system 30, arranged to by means of a set of interface drivers to provide access to specific hardware such as the memory 3 and the hardware clock. Each node S1-S4 may further comprise an operating system 25 such as a real-time operating system RTOS. The operating system may be arranged to provide a number of services to one or more applications associated to the target system. The number of services may relate to communication, scheduling, memory management, timing and health monitoring, such as providing local system time and timer services. In providing the services the operating system may be arranged to interact with the hardware 35 by means of the hardware interface system 30. Each node S1-S4 may further comprise a configuration data module (CDM) 40. The configuration data module 40 may be arranged in operative connection with the operating system 25 and the hardware interface system 30 to provide information stored within the configuration data module relating to specific configuration of memory access, scheduling and communication. As an example the configuration data module may be arranged to provide the RTOS with initialization parameters associated to execution, timing and memory configuration.

Each application of the one or more applications associated to the target system i.e. distributed avionics computer system may comprise one or more tasks, also referred to as processes. Each of the one or more tasks may denote a logical unit of computation with a single thread of control. As an example an application may be arranged to process sensor readings and control commands provided by an operator by means of one or more control laws, to continuously provide a control signal to an actuator, such as to an actuator associated to an aileron. As an example one of the tasks may be configured to perform a derivative operation on a first data variable retrieved from a sensor at time t. As a further example one of the tasks may be configured to perform a computation at time t and t+1 to provide a second data variable relating to a velocity of an object at time t and t+1 given a first data variable associated to the acceleration of the object at time t and t+1.

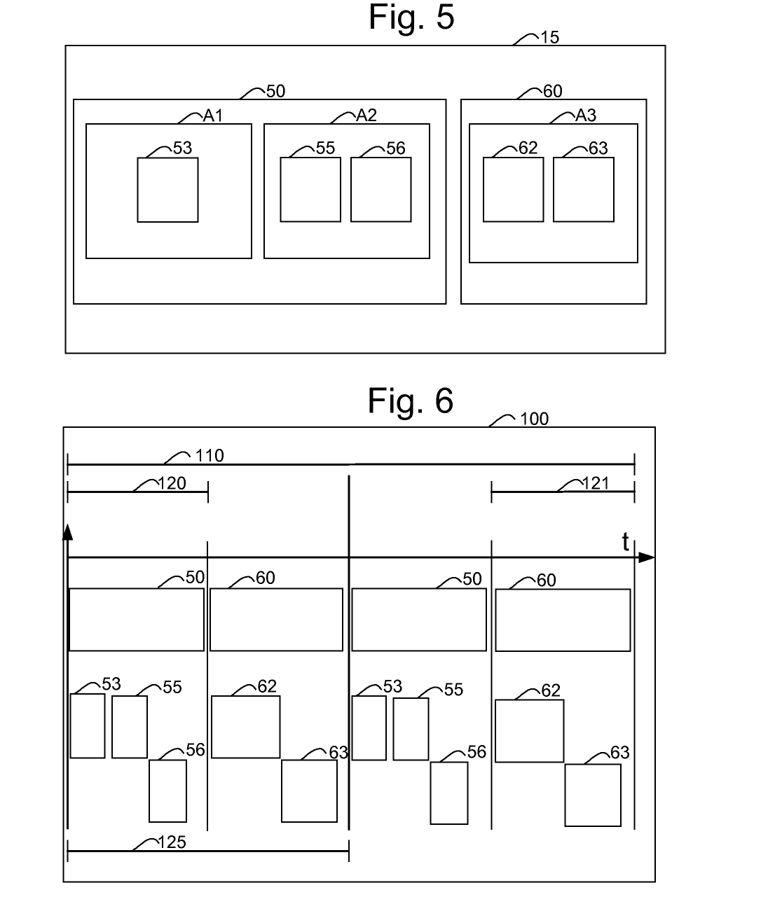

In one example each node S1-S4 of the target system may be arranged to execute a partitioning real-time operating system RTOS, compliant with ARINC 653, to allow for spatial and temporal partitioning of the set of applications comprised in an integrated modular avionics IMA partitioning module 15. With reference to FIG. 5 the IMA partitioning module 15 may comprise the one or more applications as partitioned applications, such as for example a first application A1, a second application A2 and a third application A3. Each of the applications may be divided in the IMA module 15 into one or more partitions such as for example a first partition 50 associated to the first application A1 and the second application A2 and a second partition 60 associated to the third application A3. Each of the one or more applications A1-A3 associated to the target system may further comprise one or more tasks. As an example a first task 53 may be associated to the first application A1, a second task 55 and a third task 56 may be associated to the second application A2 and a fourth task 62 and fifth task 63 may be associated to the third application A3. The one or more node S1-S4 may further each comprise an abstraction layer provided by an application programming interface (API) 20 located between application software in the IMA partitioning module and operating system OS. The API 20 may be arranged to provide a set of basic services to the set of applications required for performing their respective tasks and in order to communicate.

In one the example the API may be arranged as an application executive APEX, conforming to the ARINC 653 specifications. The implementation of the ARINC 653 specifications, for high level IMA architecture prevents error propagation when running different applications on a single processor. The partitioning enables to run applications certified to different criticality level measured by Design Assurance Level (DAL) according to the RTCA DO-178B on a single processor.

In FIG. 6 an execution schedule 100 of partitions associated to one of the nodes in the target system is illustrated in accordance with an example of the invention. The processing resources of the processor 4 in each of the nodes S1-S4 may be divided by means of configuration into one or more minor execution time frames 125 also referred to as minor processing time frames. Each of the minor execution time frames 125 may be arranged to be periodical i.e. reoccurring periodically at time instants defined by a period time. Each of the one or more partition allocated to the IMA partitioning module 15 in each of the respective nodes may be provided with at least one execution time frame, such as for example a first execution time frame 120 associated to the first partition 50, providing the partition with exclusive access to the processing resources 4 of the respective allocated node S1 for the given at least one execution time frame 120. One or several minor execution time frames may comprise one or more execution time frames associated to the partitions. As an example the one or more minor execution time frame 125 my comprise a first execution time frame 120 associated to the first partition 50 and a second execution time frame 121 associated to the second partition 60. A major execution time frame 110 may determine the intrinsic repeat cycle of the schedule defined by one or several minor execution time frames 125 in each of the nodes S1-S4.

In one example each of the partitions associated to the respective node may be assigned a time frame each of a partitioning schedule, determining the order and execution time frame for processing the partitions within each minor processing frame 125.

The execution schedule 100 may be utilized by the operating system 25 to determine when to perform context switches between different partitions and the tasks associated to the different partitions by means of clock interrupts provided from the hardware 35. For example the execution schedule 100 may determine when to perform context switches between the first partition 50 and second partition 60 and the respective associated tasks 53, 55-56, 62-63.

It should be understood that the configuration regarding the number of applications, tasks, and partitions thereby also the execution frames may differ from the illustrated example with reference to FIG. 6.

Determination of the execution schedule 100 for each of the nodes S1-S4 may be performed by means of considering the computational requirements of the applications and their associated one or more tasks in respect of the resources provided by the nodes S1-S4.

During the execution time frame for the specific partition of the one or more partitions, the tasks associated to the specific partition may be executed on a priority basis. Each task may be assigned a task frequency or period, relating to the subsequent executions also referred to as invocations of the task.

In one example each of the tasks of the distributed avionics computing system may be arranged to execute periodically. In order to execute periodically the release time, referring to when a task may start to execute, may be time-triggered at a regular i.e. at a cyclic basis, such as time triggered by means of the timer services provided by the operating system. Each task may then be defined by a set of properties associated to timing, including a period time T defining the time interval between successive releases of the task, a completion time (CT) defining the time when the task completes its execution, a deadline (D) defining the latest time when the task should complete its execution and a worst case execution time (WCET) defining the time needed to execute the task without interruption.

In one example the execution order of the one or more tasks during the execution time frame allocated to the partition may be scheduled by a priority-based pre-emptive scheduler such as scheduled in order of decreasing process frequency i.e. the tasks in each partition are executed on a rate-monotonic (RM) priority basis.

In one example the execution order of one or more tasks during the execution time frame allocated to the partition may be scheduled on a deadline-monotonic (DM) basis i.e. tasks are scheduled in order of increasing deadline for task completion.

The priority-based pre-emptive scheduler may be arranged to interrupt task execution, when some higher-priority task needs to be executed and resume it at a later instant of time. In a case wherein several tasks being assigned to the same partition are assigned with the same update frequency, first-in-first-out (FIFO) order may be used to determine internal order of execution. Hence, the execution of applications on each local node may be arranged to be controlled by a two level scheduler. The first level scheduler is arranged to schedule pre-emption of the local partitions determined from the predetermined execution time frames for each of the partitions residing in the IMA partitioning module 15 of the respective local node S1-S4. To determine the order of execution of the partitions, static predetermined priorities may be assigned to the partitions prior to system run-time. The second level scheduler is arranged to schedule the one or more tasks within each of the partitions on a priority pre-emptive basis during the predetermined execution time frame for the partition. As an example the first partition 50 may be allocated to a first node S1 and assigned with the first execution time frame 121 of for example 10 ms and with a period of 25 ms corresponding to a repeat i.e. update frequency of 40 Hz. The first task 53, second task 55 and third task 56 may be associated to the first partition 50. The first and second task may be assigned with a task frequency of 40 Hz and the third task may be assigned with a task frequency of 20 Hz. The second partition 60 may be allocated to the node S1 and assigned with the second execution time frame 120 of for example 12 ms and with a period of 25 ms corresponding to a repeat i.e. update frequency of 40 Hz. The fourth task 62 and fifth task 63 associated to the second partition 60 may be assigned with a task frequency of 40 Hz and 20 Hz respectively. Hence, the instances of the first task 53 and the second task 55 are executed once each 25 ms time period, the instances of the third task 56 are executed once each 50 ms time period. The instances of the fourth task 62 are executed once each 25 ms time period and the instances of the fifth task 63 are executed once each 50 ms time period. The major time period 110 for the schedule may then be determined to be the least common multiple of the execution time period of each of the tasks associated to each of the nodes S1-S4, such as for example the least common multiple of 25 ms and 50 ms corresponding to 50 ms, which is the time period where after the sequence of execution of task instances i.e. schedule may repeat cyclically. It is to be noted that one or more task instances, such as the instance of the third task 56 and fifth task 63 may be pre-empted during a first execution of its associated partitions 50, 60 and later be resumed during a subsequent execution of its associated partition 50, 60. The third task 56 may for example be pre-empted depending on if the CT of the third task 56 together with the CT of one or more other tasks residing in the same partition such as for example the CT of the first task 53 and second task 55 exceeds the time period assigned to the respective partition 50.

In one example the task processing frequency may be configured to be selected from a harmonic set of frequencies with corresponding periods such as for example the set of frequencies comprising 40 Hz, 20 Hz, 10 Hz and 5 Hz. The task processing frequency may be selected on basis of the respective task requirements for frequent execution time.

In one example the set of task processing frequencies is provided as a set of system global processing frequencies. Hence, all tasks distributed across the distributed system of interconnected nodes S1-S4 may be assigned with a task processing frequency each, selected from the set of predetermined global task processing frequencies. Thus, all tasks distributed onto the one or more nodes S1-S4 are assigned with one processing frequency and/or processing period time each, determined from the set of global processing period frequencies.

In one example the task processing frequency of each specific task may be selected on basis of how often input data are updated or how often subsequent input data significantly changes in its parameter value.

In one example the task processing frequency of each specific task may be selected on basis of how often output data from the process is required by other parts of the system.

In one example the task processing frequency of each specific task may be selected on basis of a combination of how often input data are updated or how often subsequent input data significantly changes in its parameter value and/or how often output data from the process is required by other parts of the system

In one example information to be provided to the configuration data module 40 associated to each of the nodes S1-S4 of the target system may be constructed and/or managed using a set of configuration files. The set of configuration files may provide various elements of the distributed avionics computer system with configuration information relating to scheduling, memory access and communication. The set of configuration files may for example provide the information to the operating system OS and/or hardware interfaces and/or other components of the respective system nodes S1-S4. Construction of the set of configuration files may be performed in several ways using different forms. The configuration files may for example be in the form of some programming language data declarations, in general markup language form such as for example in eXtensible Markup Language (XML), or in some text-based proprietary format.

In one example the set of configuration files may be constructed using model based development tools.

In one example a first subset of the set of configuration files may be automatically generated based on a second subset of the set of configuration files.

The configuration data from the configuration files associated to partitioning of the set of applications and other OS related attributes can later be linked to and compiled with source code associated to for example the set of applications to provide executable files in machine readable format.

In one example the configuration files may be compiled into binary format using a RTCA DO-178B certified compiler.

In one example a subset of the set of configuration files may be associated to an ARINC 653 implementation associated to each of the nodes S1-S4. The subset of configuration files, may describe the characteristics of partitions, their interactions, and their time and resource requirements. After the subset of configuration files is loaded and processed, the ARINC 653 based RTOS associated to each of the nodes S1-S4 may provide the behavioral ARINC 653 support by allocating memory for the system partitions, setting up memory protection structures, and allocating other system resources.

In one example of the present invention additional configuration data may be constructed from a set configuration files comprising a number of subsets of configuration files. Each of the subset of configuration files may comprise one or more configuration file associated to one of a group comprising system hardware topology, software topology, data messages, system timing, and applications.

In one example each of the configuration files from the subset of configuration files may be used as input data to a set of operational tools. The set of operational tools may be arranged to process information extracted from one or more of each of the configuration files so as to automatically provide the additional configuration data related to for example connectivity between the set of applications.

In one example the set of operational tools may be arranged to provide machine readable configuration data associated to connectivity. The machine readable configuration data associated to connectivity may comprise instructions relating to I/O traffic for control of various I/O mechanisms arranged to operate within the distributed avionics computer system such as for example at least an I/O partition or I/O processor associated one or more of each of the nodes S1-S4.

As a result of the operations of the set of operational tools the preconfigured traffic schedule may be generated automatically off-line for each of the nodes S1-S4 as a static description of the network transactions within a major bus period that is periodically repeated. The preconfigured traffic schedule is statically determined i.e. it is predetermined from the allocation of each of the one or more data messages into the plurality of communication time-slots when each of the one or more data messages is sent onto the network 2. It is further predetermined which of the one or more data messages that comprise which one or more data variable. The preconfigured traffic schedule can be generated for a predetermined distributed avionics computer system based on configuration files comprising configuration data associated to configuration of hardware and software.

The operational tools may in one example be implemented as software operating in a computer environment separated from the distributed avionics computer system.

In one example a host system is provided in accordance with an example of the invention. The host system may comprise standard hardware associated with one or more general purpose computer, such as for example hardware found in a typical workstation, desktop, laptop or server. The host system may comprise a plurality of general purpose computers interconnected in a network. The host system may comprise one or more general purpose operating system (GPOS) to provide an interface to services from the one or more general purpose computers. Each of the one or more general purpose computers may comprise typical components such as for example one or more processor, memory, backplane or other additional computer components known within the art.

In one example the host OS may be a non real-time GPOS such as for example the Windows® XP OS available from Microsoft Corporation, MAC OS System X available from Apple Computer, Solaris OS available from Sun Microsystems, UNIX available from various sources or Linux available from various sources.

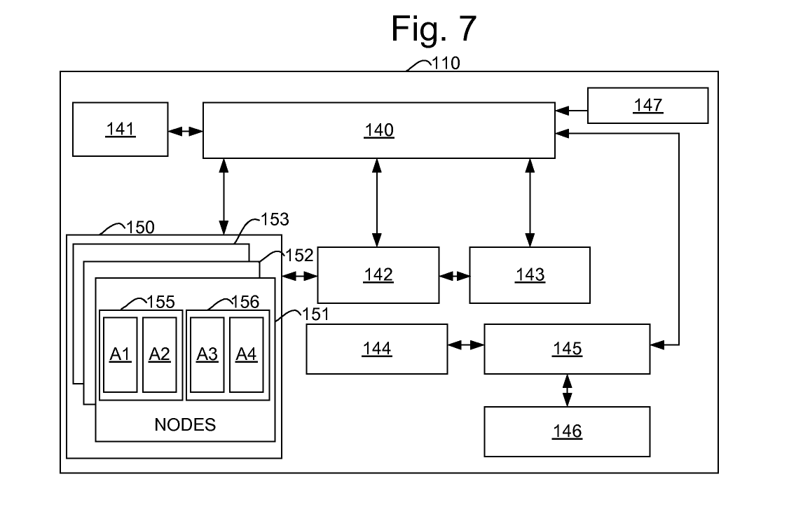

With reference to FIG. 7 there is illustrated a simulation framework 110 arranged to be orchestrated inside the host system in accordance with an example of the present invention. The simulation framework is arranged to interface with the OS and hardware associated to the host system in order to provide an interface to execute one or more applications A1-A4 associated to the target system based on un-modified application source code or un-modified binaries associated to the one or more applications wherein the binaries are compiled for the target system. By providing the interface to execute the one or more applications A1-A4 using un-modified application source code or un-modified binaries compiled for the target system the simulation framework 110 provide means for host based simulation of the behavior of the one or more application orchestrated in the target system.

In one example the simulation framework 110 may provide means for host based simulation of interaction between the one or more applications associated to the target system and the set of subsystems AVS coupled to the target system.

In one example in order to provide the interface to execute the one or more target software applications the simulation framework is arranged to provide a number of system services needed for execution of the target software applications based on un-modified target software application source code.

In one example in order to provide the interface to execute the one or more target software applications in un-modified binary format compiled for the target system the simulation framework may be arranged to provide an instruction set simulation (ISS) representative of the instruction set architecture (ISA) of the target system.

In one example the number of system services provided by the simulation framework may correspond to one or more system service defined by the API of the ARINC 653 specification referred to as application executive (APEX). The one or more system service can according to the specification each be related to a number of major categories comprising partition management, process management, time management, intra-partition communication, inter-partition communication and health monitoring.

In one example the simulation framework 110 comprise a simulation module 140 arranged to provide coordinated activation of a number of functional modules comprised in the simulation framework 110. The functional modules may be software objects, such as for example executable software objects. The coordinated activation of the functional modules may refer to providing processing resources, communication resources and memory resources. The simulation module 140 may for example provide processing resources available to the host system to one or more of the functional modules at pre-defined instants of time according to a simulation schedule. One or more functional modules may be active at the same time.

In one example the simulation module 140 may comprise a time-server arranged to provide a cyclic based execution model. In one example the time-server is arranged to divide the overall processor capacity, available to the host system between the different partitions 50, 60 associated to the one or more applications A1-A4 associated to the target system.

In one example the simulation framework comprise a monitor module 141 arranged to provide means for supervision and monitoring of processes associated to the simulation framework and the number functional modules during active simulation and/or during configuration of the simulation framework 110. As an example the monitor module 141 may be arranged to visualize configuration and characteristics associated to the target system in a first window of a graphical user interface (GUI) and behavior of the target applications during run-time in a second window of the GUI.

The simulation framework may comprise a virtual platform module 142 arranged to simulate one or more component of the target system i.e. distributed avionics computer system. The virtual platform module 142 may for example be arranged to simulate behavior of one or more network 2 and/or communication bus arranged to interconnect the distributed avionics computer system. The virtual platform module 142 may be arranged to operate in conjunction with network i.e. communication characteristics provided from a configuration module 145. The communication characteristics may comprise bandwidth, latencies and protocol. As an example the virtual platform module may be arranged to simulate a physical switched Ethernet network, arranged to implement a time divisional multiple access (TDMA) protocol.

In one example the virtual platform module 142 may be arranged to provide simulation of additional components, such as for example a primary flight data (PFD) display arranged to provide visual information based on ARINC 661 display data streams provided from target applications and/or a simulated physical operating environment.

In one example the simulation framework 110 comprises a model library module 143. The model library module 143 comprise information related to a number of physical models of one or more systems to which the distributed avionics control system i.e. target system is coupled and arranged to interact with. The physical models may for example be models of the set of subsystems of the aerial vehicle AVS, such as for example a mathematical model describing a fuel system with associated variables relating to fuel consumption, maximum fuel capacity and current fuel supply. The physical models may further comprise models representing the physical environment in which the aerial vehicle is intended to operate. The models associated to the environment may relate to models of aerodynamic effects acting on the aerial vehicle based on variables such as for example altitude, attitude and actuator positions. The models of aerodynamics may for example comprise six degrees of freedom (6-DOF) flight dynamics.

In one example the model library module 143 may comprise a model state module. The model state module may be arranged to update variables and/or states associated to the physical models of the model library module during simulation run-time in response to received data and/or in response to timed events. The model state module may be communicatively coupled to the virtual platform module 142 in order to provide means for two-way communication between the one or more applications A1-A4 and the model library module 143. The communication between the one or more applications A1-A4 and the model library module 143 may comprise variables related to properties associated to the physical models representative of properties of the subsystems and/or environment of the aerial vehicle.

In one example the simulation module 140 is coupled to a configuration module 145 arranged to configure the simulation framework 110. The configuration module 145 is coupled to a configuration table loader module 144, arranged to import configuration tables or configuration data comprising information of table-driven operations associated to the target system and/or the target applications. The configuration tables may specify operations relating to processing, communication and memory access, these tables can be used as inputs to the configuration manager to define the characteristics of the target system. As an example the characteristics of the target system may comprise characteristics associated to I/O allocation, routing, data format conversion, bandwidth limitations, I/O data formats, scheduling of partitions, memory allocation, memory limitations, health monitoring reactions and general node characteristics such as for example cache memory size and random access memory (RAM) size. The configuration tables may for example be imported into the simulation framework 110 by parsing configuration files in a XML format into machine readable instructions. The configuration module is further coupled to an application loader module 146 arranged to import the target applications. The one or more applications A1-A4 can be imported into the application service module 150 in un-modified format i.e. the target applications can be imported using un-modified source code.

In one example the configuration module 145 may be arranged to configure connectivity between at least one of the one or more applications A1-A4 and at least one of the variables and/or state associated to one of the physical models of the model library module 143. As an example at least a first application arranged to control fuel injection in the target system may be configured in the simulation framework 110 to provide control commands via the virtual platform module 142 to at least a first physical model descriptive of the fuel in the fuel tank and at least a second physical model descriptive of jet engine propulsion. The at least second physical model may further be configured in the simulation framework 110 to provide variables related to the currently provided engine power via the virtual platform module 142 to at least a second target application arranged to control thrust.

In one example the simulation framework 110 comprise a test module 147 arranged to provide means for functional and behavioral testing of the one or more applications A1-A4 associated to the distributed avionics computer system. The test module may for example comprise a number of predetermined test scripts, configurable scripts and/or test functions which may be activated and/or manipulated by a user of the simulation framework 110. As an example the test module may 147 provide a fault-injection-test functionality allowing one or more fault condition to be inputted to one or more of the target applications during simulation run-time in order to test robustness.

In one example an application service module 150 is provided. The application service module 150 is arranged to host the partitioned target applications A1-A4 grouped in a number of virtual partitions 155-156 associated to a number of virtual nodes 151-153 corresponding to the configuration of the target system. The application service module 150 is arranged to provide services required for executing the one or more application A1-A4 in correspondence with the imported target configuration tables. The application service module 150 may be arranged to host the target applications in one or more memory areas associated to the host system.

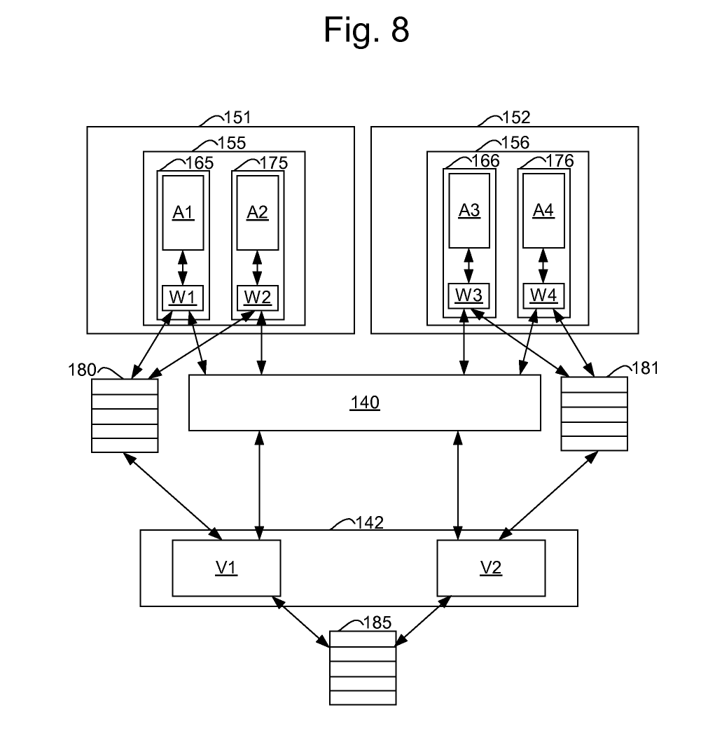

In one example with reference to FIG. 8 each of the one or more applications associated to the target system are provided with a wrapper layer W1-W4. The wrapper layers associated to the one or more applications A1-A4 are arranged to provide an interface to the functional modules of the simulation framework 110 such as for example the simulation module 140 and the virtual platform module 142. Each of the number of wrapper layers are arranged to wrap services requested from the one or more applications A1-A4 via the APEX API onto the services provided by the simulation framework 110 such as for example services related to process control and communication.

In one example the virtual nodes 151-153 in the host system corresponding to the nodes S1-S3 in the target system may be implemented as a group of UNIX processes, one for each virtual partition 155-156 allocated to the respective virtual node.

In one example each of the one or more applications A1-A4 may be implemented as POSIX threads. Each of the POSIX threads may be arranged to execute within the UNIX process associated to each of the virtual partitions 155-156.

In one example an init process may be associated to each UNIX process. Each of the init processes may be arranged to create the POSIX threads associated to the target applications. Information about the target applications in each of the virtual partitions i.e. UNIX processes can be retrieved by the init process via the configuration tables associated to the target system.

In one example one or more communication sub-module V1-V2 associated to the virtual platform module 143 may be arranged to execute target software I/O instructions, such as for example I/O instructions arranged to be loaded to and executed within one or more embedded I/O mechanism associated to the target system. The one or more communication sub-module V1-V2 may further each comprise a porting layer. The porting layer may be arranged to provide means for communication between the target applications executing in the host system using target I/O routines based on providing one or more replacement routine. The porting layer comprise replacement routines for low level routines such as for example direct memory access (DMA) schemes, I/O routines, MIL-STD 1553 and alternative interfaces to the virtual nodes 151-153.

As an example relating to the case wherein the nodes S1-S4 associated to the target system each comprises a dedicated I/O controller (IOC) or dedicated I/O processor (IOP) coupled via PCIe interface, the one or more communication sub-module V1-V2 may be arranged to import and execute routines associated to the target IOP or IOC. The memory associated to the PCIe interface in the target system used for communication using DMA between the IOP/IOC and the one or more applications in target system may for example be replaced in the host system by a shared memory 180-181. The shared memory may be implemented as for example a POSIX shared memory with the same memory size and memory layout as in the target system. Configuration of the POSIX shared memory may be arranged to be performed based on using the configuration tables associated to the target system.

In the illustrated example with reference to FIG. 8 a first application A1 and a second application A2 associated to a first virtual node 151 are arranged to communicate with a first communication sub-module V1 using a first shared memory 180 via an associated first wrapper layer W1 and a second wrapper layer W2 respectively. A third application A3 and a fourth application A4 associated to a second virtual node 152 are arranged to communicate with a second communication sub-module V2 using a second shared memory 181 via an associated third wrapper layer W3 and a fourth wrapper layer W4 respectively. The first application A1 and second application A2 are arranged to execute as a first thread 165 and a second thread 175 respectively within a first virtual partition 155. The third application A3 and fourth application A4 are arranged to execute as a third thread 166 and a fourth thread 176 respectively within a second virtual partition 156. The virtual partition 155-156 may be implemented as UNIX processes and the target applications A1-A4 may be implemented as POSIX threads. The first communication sub-module V1 and the second communication sub-module V2 are arranged to provide means for communication between the first virtual node 151 and the second virtual node 152. Communication can be provided between the first and second virtual node 151-152 based on a third shared memory 185. Communication using the third shared memory 185 and/or additional routines associated to the porting layer of the first communication sub-module V1 and the second communication sub-module V2 may replace communication associated to the target system using a physical switched Ethernet network interconnecting the nodes S1-S4.

In one example the communication sub-modules V1-V2 are arranged to provide simulation of inter-partition communication using ARINC 653 sampling and/or queuing ports.

In one example the simulation module 140 may utilize synchronization objects such as for example semaphores to coordinate the activation of the functional modules.

In one example the simulation module 140 may be arranged to implement a membership protocol arranged to coordinate the activation i.e. execution of the functional modules and/or component processes associated to the functional modules. The component processes associated to the functional modules may for example comprise the POSIX threads and/or UNIX processes.

In one example the functional modules and/or component processes associated to the functional modules are arranged to request execution time through the time-server. The time-server is arranged to control progression of simulated target system time and determine which of the functional modules and/or component processes associated to the functional modules that are next in order to be released i.e. executed.

In one example each of the members may be arranged to request a time to execute from the time-server based on configuration data associated to the target system. As an example each member may repeatedly request a time to execute based on the processing period or frequency allocated to processing components, such as for example tasks, threads and/or processes associated to the member.

In one example message queues are used for sending messages between the time-server and the members i.e. the functional modules and/or component processes associated to the functional modules registered as members. One message queue is used for each receiver of messages, i.e. one message queue is associated to the time-server and one message queue is associated to each member. The message queues may be initialized and created for every functional modules and/or component processes associated to the functional modules independently of each other. The initialization of message queues is controlled via membership request from the functional modules and/or component processes associated to the functional modules to the time-server, wherein time-server can determine if the membership already exists or not. In on one example a preconfigured global queue is initialized via the time-server to control all incoming requests to the time-server.

When the functional modules and/or component processes associated to the functional modules requests execution time from the time-server, the functional modules and/or component processes associated to the functional module is arranged to listen to its associated message queue for a message sent from the time-server granting the member permission to execute. Before the message granting the member permission to execute is sent from time-server the member will be in blocking mode. Thus, blocking message queue reads can be used as a mechanism to stop member execution until the time-server grants the member permission time to execute. After each member has completed its processing i.e. execution cycle, the member will request a new execution time and stop listening for the message granting the member permission to execute.

In one example read and write operations can be performed to the message queues both in blocking and non blocking mode.

In one example a state-machine is used to process requests from the members arriving via the preconfigured global queue, associated to the time-server. The state machine is arranged register information related to the members in a member module and determine the order of execution in a scheduler module. The information related to the members may comprise identity and scheduling data. The time-server is arranged to perform transitions between at least two states associated to the state machine A first state also referred to as a waiting state, comprises waiting for messages to arrive on its associated message queue. When the time-server receives a message and subsequently un-pack the message, a transition to a second state is performed. When the action such as for example execution process requested by the message is performed the time-server return to the first state.

In one example the virtual platform module 142 may be arranged to request execution time from the simulation module 140 based on configuration data associated to one or more communication protocol. As an example the virtual platform module 142 may be arranged to request execution time based on one or more timed events from a predetermined time-slot schedule traffic schedule associated to the target system. The execution time may be requested by the virtual platform module 142 using the porting layer.

In one example in response to receiving execution time for a particular timed event the virtual platform module 142 may be arranged to determine which variables to send to the model state module.

In one example in response to receiving execution time for a particular timed event the first communication sub-module V1 of the virtual platform module 142 may be arranged to determine which variables to send to the model state module and/or to the second the second communication sub-module V2.

In one example the model state module associated to the model library module 143 may be arranged to request execution time from the simulation module 140.

In one example the model state library may be arranged to request execution time from the simulation module 140 on a periodic basis, such as for example on a 40 Hz basis.

In one example the model state library may be arranged to request execution time from the simulation module 140 based the one or more timed events from the predetermined time-slot schedule traffic schedule associated to the target system determining the flow of data i.e. variables received from the virtual platform module 142.

In one example the model state module may be arranged to request execution time based on properties of the physical model such as for example a fixed or a variable time step associated to one or more differential equation associated to the physical models.

In one example in response to receiving permission to execute the mode state module may be arranged to process one or more of the physical models to provide updated variables based on variables received variables and/or based on the progression of time.

In one example the time-server may be arranged to implement a non-linear, but always incrementing simulated target system time. The simulated target system time may be controlled by the time-server based on receiving time requests from the members and moving time forward to the next requested time. Thus, the simulated target time advance as fast as it can with respect to the current work load and available computing resources associated to the host system. Thus, the simulated target system time reflects the difference in capacity between processing resources associated to the host system and the target system the in order to maintain a correct sequence of data flow in relation to the target system.

In one example the time-server may comprise a scheduler arranged to determine the correct order of member execution. The order may be calculated based on the requested start times and/or expected end times sent to the time-server by the members. Each time one or more of the members is done executing or requests time to execute the state machine is arranged to query the scheduler to determine which member that is to be executed next in order. The requested start times and/or expected end times may be included in the messages sent to the time-server by the members.

In one example the requested start times and/or expected end times may determined from the configuration tables associated to the target system.

In one example the time-server is arranged to be in the waiting state until all registered members have requested a time to execute.

In one example a scale factor may be applied to the simulated target system time associated to the time-server in order to enable speeding up or slowing down the execution of the target applications. The scale factor may be modified during execution by the interacting with the configuration module 145.

In one example the host system may comprise additional modules arranged in the model library module 143 and/or simulation module 140 in order to provide the possibility for flying virtually. The additional modules may comprise information and processing components arranged to provide environmental maps and three-dimensional graphics in response to orchestration of the target applications in the host system and/or in response to input control commands. The additional modules may further comprise information and/or processing components arranged to provide virtual mission scenarios and/or operating scenarios, so as to allow an operator to fly virtual missions. The mission scenarios may for example include entities such as virtual opponents and/or “friends”. This allows operators such as pilots to test system functionality before implementing it in the target system.

In one example the host system can be coupled to an assembly cockpit mock-up assembly. The cockpit mock-up assembly may comprise various components typically found in the cockpit of aerial vehicles such as knobs, joysticks, display devices and gages. The components may be coupled to the host system to provide means for simulated flight in real-time based on the orchestration of target application in the host system.

In one example the host system may comprise a non-volatile memory, a data processing device such as a microprocessor and a read/write memory. The non-volatile memory has a first memory portion wherein a computer program, such as an operating system, is stored for controlling the function of the distributed avionics computing system. Further, the host system comprises a bus controller, a serial communication port, I/O-means, an A/D-converter, a time date entry and transmission unit, an event counter and an interrupt controller. The non-volatile memory also has a second memory portion.

A computer program comprising routines for controlling the function of the distributed avionics computing system is provided. The program may be stored in an executable manner or in a compressed state in a separate memory and/or in the read/write memory.

When it is stated that the data processing device performs a certain function it should be understood that the data processing device performs a certain part of the program which is stored in separate memory, or a certain part of the program which is stored in read/write memory.

The data processing device may communicate with a data port by means of a first data bus. The non-volatile memory is adapted for communication with the data processing device via a second data bus. The separate memory is adapted to communicate with data processing device via a third data bus. The read/write memory is adapted to communicate with the data processing device via a fourth data bus.

When data is received on the data port it is temporarily stored in the second memory portion. When the received input data has been temporarily stored, the data processing device is set up to perform execution of code in a manner described above. According to one example, data received on the data port comprises information regarding which of the target applications to import into the host system, configuration data associated to the target system and configuration data associated to the interactions between the target system and the target applications. This information can be used by the host system so as to orchestrate the target application associated to the target system i.e. the distributed avionics computing system in the host system so as to simulate and/or test the behaviour of the target applications orchestrated in the target system.

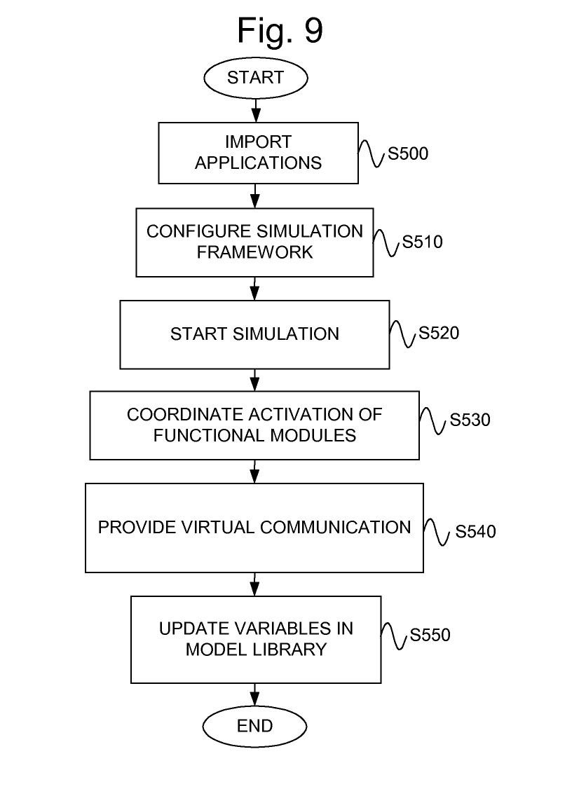

An example of the invention relates to a computer programme comprising a programme code for performing the method steps depicted with reference to FIG. 9, when the computer programme is run on a computer.

An example of the invention relates to a computer programme product comprising a program code stored on computer-readable media for performing the method steps depicted with reference to FIG. 9, when the computer programme is run on the computer.

An example of the invention relates to a computer programme product directly storable in an internal memory of a computer, comprising a computer programme for performing the method steps depicted with reference to FIG. 9, when the computer programme is run on the computer.

FIG. 9 schematically illustrates a flow diagram of a method according to an example of the present invention. This example relates to simulating and/or testing a number of partitioned applications arranged to be periodically executed on a target system wherein the target system is a distributed avionics system of an aerial vehicle 1.

In a first method step S500 the target applications are imported into the host system. This means that the one or more applications associated to the target system are imported into the host system in un-modified form such as for example using un-modified source code or source code compiled using a compiler, compatible with the target system i.e. distributed control computer environment. After the method step s500 a subsequent method step s510 is performed

In the method step S510 the simulation framework 110 is configured. This means that target system characteristics is provided to the host system via the configuration module 145. The target system characteristics may be provided to the host system using configuration tables associated to the target system. After the method step S510 a subsequent method step S520 is performed.

In the method step S520 simulation is started. This means that entities associated to the target applications such as for example the UNIX processes, POSIX threads and the virtual platform module are initialized and start provide requests for membership to the simulation module 140. The simulation module 140 then grants membership and register each of the entities as a member. After the method step S520 a subsequent method step S530 is performed.

In the method step S530 activation of the functional modules are coordinated. This means that the members request execution time from the simulation module 140. Each request for execution time comprises information on the instant of time when the member is scheduled to start executing. The simulation module 140 then grants permission for the member to execute and adjust simulated target system time forward to the instant of time requested by the member. The simulation module 140 control the execution order among the members based on the requested instant of time to execute and the current simulated target system time. After the method step S530 a subsequent method step S540 is performed.

In the method step S540 virtual communication is provided. This means that the virtual platform module 142 and/or communication sub-module V1-V2 provides requests for permission to execute to the simulation module 140. Each request for execution time from the virtual platform module comprises information on the instant of time when the virtual platform module is scheduled to start executing determined from configuration data, related to for example the predetermined traffic schedule. The simulation module 140 then grant permission to execute based on current simulated target system time. After the method step S540 the method ends in one example and may be repeated starting with the method step S500 to perform a new simulation or test session.

In another example the method step S540 is followed by that a subsequent method step S550 is performed. In the method step S550 variables in the model library is updated. This means that the model library module 143 provides requests for permission to execute to the simulation module 140. Each request for execution time from the model library module 143 comprises information on the instant of time when the model library module 143 is scheduled to start executing determined from configuration data, related to for example the predetermined traffic schedule and/or the fixed or the variable time step associated to one or more differential equation associated to the physical models. After the method step S550 the method ends in one example and may be repeated starting with the method step S500 to perform a new simulation or test session.

Many modifications and variations will be apparent to practitioners skilled in the art without departing from the scope of the invention as defined in the appended claims. The examples were chosen and described in order to best explain the principles of the invention and its practical applications, thereby enabling others skilled in the art to understand the invention for various examples and with various modifications as suited to the particular use contemplated.

1. An avionics Avionics application host system for simulating and/or testing a plurality of partitioned applications arranged to be periodically executed on a target system, wherein the target system is a distributed avionics control system of an aerial vehicle, the host system comprising:
a plurality of functional modules comprising:
an application module arranged to import said plurality of partitioned applications in un-modified form,
a configuration module arranged to configure the operations of the host system, based on configuration tables associated to the target system, wherein said configuration of the operations relates to specifications of execution, communication and memory access associated to the partitioned applications,
at least one communication module associated with the imported partitioned applications arranged to provide communication between the partitioned applications and between component processes within the partitioned applications, based on said configuration tables,
a control module arranged to provide coordinated execution time to the functional modules, based on receiving a plurality of requests for execution time from the functional modules, wherein each of the plurality of requests comprise information related to requested execution start-time, wherein the control module further is arranged to determine the order of execution among a plurality of requests, based on said requested execution start-time, and
a service module associated with each imported partitioned application arranged to provide services to the imported partitioned applications related to execution and communication via standard target application interface, based on wrapping requests for services from the imported partitioned applications via a plurality of wrapper objects on to the communication module and control module, so as to enable execution of the imported partitioned applications and to preserve the temporal order of events related to communication and execution.

2. The avionics application host system according to claim 1, wherein the control module is arranged to simulate target system time based on receiving the plurality of requests for execution time from the functional modules and arranged to advance simulated target system time to a subsequent requested start time in rising order.

3. The avionics application host system according to claim 1, wherein the control module is arranged to operate in accordance with a membership protocol and communicate with the functional modules, the partitioned applications and component processes associated to the partitioned applications, based on message queue objects.

4. The avionics application host system according to claim 1, wherein the host system comprises a model module arranged to provide a plurality of physical models of the operating environment of the target system and subsystems coupled to the target system.

5. The avionics application host system according to claim 4, wherein said configuration module is further arranged to provide configuration associating at least one of the plurality of partitioned applications to at least one variable of at least one of the plurality of physical models.

6. The avionics application host system according to claim 5, wherein the at least one communication module comprises a plurality of communication sub-modules, and wherein and the configuration module further is arranged to provide configuration associating at least one of the plurality of partitioned applications to at least one variable of at least one the plurality of physical models via at least one of the plurality of communication sub-modules.

7. The avionics application host system according to claim 6, wherein said plurality of communication sub-modules provide communication between component processes associated to each of the plurality of partitioned applications based on at least a first shared memory object associated to each of the plurality of communication sub-modules, and wherein the plurality of communication sub-modules provide communication between the number of partitioned applications associated to different communication sub-modules based on a second shared memory object.

8. The avionics application host system according to claim 1, wherein the at least one communication module is arranged to simulate a time-triggered Ethernet network based on a communication schedule provided by the configuration tables and the second shared memory object associated to the at least one communication module.

9. The avionics application host system according to claim 1, wherein at least an operating system associated to the target system is a real-time operating system, and wherein at least an operating system associated to the host system is a general purpose operating system.

10. The avionics application host system according to claim 1, wherein the plurality of partitioned applications is ARINC 653 applications, and wherein the service module is arranged to provide ARINC 653 services.

11. The avionics application host system according to claim 10, wherein ARINC 653 partition service is mapped to UNIX processes, and wherein the partitioned applications are executed within its associated UNIX process as POSIX threads.

12. A flight simulator, comprising:
an avionics applications host system a plurality of functional modules comprising:
an application module arranged to import said plurality of partitioned applications in un-modified form,
a configuration module arranged to configure the operations of the host system, based on configuration tables associated to the target system, wherein said configuration of the operations relates to specifications of execution, communication and memory access associated to the partitioned applications,
at least one communication module associated with the imported partitioned applications arranged to provide communication between the partitioned applications and between component processes within the partitioned applications, based on said configuration tables,
a control module arranged to provide coordinated execution time to the functional modules, based on receiving a plurality of requests for execution time from the functional modules, wherein each of the plurality of requests comprise information related to requested execution start-time, wherein the control module further is arranged to determine the order of execution among a plurality of requests, based on said requested execution start-time, and
a service module associated with each imported partitioned application arranged to provide services to the imported partitioned applications related to execution and communication via standard target application interface, based on wrapping requests for services from the imported partitioned applications via a plurality of wrapper objects on to the communication module and control module, so as to enable execution of the imported partitioned applications and to preserve the temporal order of events related to communication and execution,
wherein the avionics application host system comprise an input module arranged to provide means to input control commands associated to simulated flight operations, and wherein the avionics application host system comprise display means arranged to provide visual feedback based on the simulated flight operations.

13. A method for simulating and/or testing a plurality of partitioned applications arranged to be periodically executed on a target system, wherein the target system is a distributed avionics system of an aerial vehicle, the method comprising:
importing the partitioned applications in un-modified form into an avionics application host system,
configuring operations of the avionics application host system associated to the partitioned applications based on using configuration tables associated to the target system,
initializing the imported partitioned applications,
wrapping requests for services related to execution from the imported partitioned applications via wrapping layers to a control module, based on transmitting at least one message comprising information related to a requested execution start-time,
granting execution time based on the requested execution start times,
providing virtual communication based on transmitting at least one message comprising information related to a requested execution start-time from the communication module to the control module, and
maintaining a simulated target system time and advancing the simulated target system time to the next requested start-time in order, so as to execute the imported partitioned applications and to preserve the temporal order of events related to communication and execution.

14. The method according to claim 13, further comprising:
updating data, said data comprising variables associated to a plurality of physical models, based on providing a request for execution time for processing of the physical models to the control module, and
exchanging variables between the partitioned applications and variables associated to the plurality of physical models.

15. A computer program product, comprising:
a non-transitory computer readable medium; and
a program code recorded on the computer readable medium for performing when said computer program is run on a computer a method for simulating and/or testing a plurality of partitioned applications arranged to be periodically executed on a target system, wherein the target system is a distributed avionics system of an aerial vehicle, the method comprising:
importing the partitioned applications in un-modified form into an avionics application host system,
configuring operations of the avionics application host system associated to the partitioned applications based on using configuration tables associated to the target system,
initializing the imported partitioned applications,
wrapping requests for services related to execution from the imported partitioned applications via wrapping layers to a control module, based on transmitting at least one message comprising information related to a requested execution start-time,
granting execution time based on the requested execution start times,
providing virtual communication based on transmitting at least one message comprising information related to a requested execution start-time from the communication module to the control module, and
maintaining a simulated target system time and advancing the simulated target system time to the next requested start-time in order, so as to execute the imported partitioned applications and to preserve the temporal order of events related to communication and execution.
